(19) United States
(12) Patent Application Publication
(10) Pub. No.: US 2025/0239243 A1
(43) Pub. Date: Jul. 24, 2025

(54) MUSIC GENERATING METHOD AND APPARATUS, DEVICE, STORAGE MEDIUM, AND PROGRAM

(71) Applicant: Beijing Zitiao Network Technology Co., Ltd., Beijing (CN)

(72) Inventors: Haonan Chen, Los Angeles, CA (US); Chengli Feng, Beijing (CN); Weisi Wang, Beijing (CN)

(21) Appl. No.: 18/837,174

(22) PCT Filed: Feb. 27, 2023
(86) PCT No.: PCT/CN2023/078545

§ 371 Date: Aug. 8, 2024

(30) Foreign Application Priority Data
Feb. 28, 2022 (CN) 202210190764.6

(51) Int. Cl. G10H 1/00; G10H 1/36

(52) U.S. Cl. CPC G10H 1/0025; G10H 1/0033; G10H 1/361; G10H 2210/125; G10H 2240/325

(57) ABSTRACT

There are provided a method, apparatus (1100, 1200), device, storage medium, and program. The method includes: determining a music template, the music template comprising a plurality of tracks, each track being divided into at least one time period; obtaining a multimedia segment corresponding to each time period of each track from a database according to the music template, wherein the multimedia segment corresponding to each time period of each track comprises audio information obtained by a user playing a track melody corresponding to the time period of the track, and the database comprises a plurality of multimedia segments played by a plurality of users (S702); joining audio information in multimedia segments corresponding to respective time periods of each track respectively, to obtain a track audio corresponding to each track (S703); and generating target music by combining the track audio corresponding to respective tracks (S704).

### CROSS REFERENCE TO RELATED APPLICATIONS

This disclosure claims priority to Chinese Patent Application No. 202210190764.6, filed with the Chinese Patent Office on Feb. 28, 2022, and entitled “MUSIC GENERATING METHOD AND APPARATUS, DEVICE, STORAGE MEDIUM, AND PROGRAM”, which is incorporated herein by reference in its entirety.

### FIELD

Embodiments of the present disclosure relate to the field of Internet technologies, and in particular, to a method, apparatus, device, storage medium, computer program product, and computer program for generating music.

### BACKGROUND

With the development of terminal technologies, a user expects to compose music or play music by a terminal device, thereby increasing interest.

At present, a terminal device may install Karaoke software, and play background music of a music composition via the Karaoke software, and a user follows the background music to perform Karaoke, so as to compose music or play music.

However, the described manner of composing/playing music is monotonous and lacks cooperation and interactivity between users.

### SUMMARY

Embodiments of the disclosure provide a method, apparatus and device, a storage medium, a computer program product, and a computer program for generating music, to solve the problems of poor cooperation and interaction in a music composing/playing process.

In a first aspect, an embodiment of the disclosure provides a method for generating music, comprising:
determining a music template, the music template comprising a plurality of tracks, each track being divided into at least one time period, and the plurality of tracks being orchestrated tracks of music;
obtaining a multimedia segment corresponding to each time period of each track from a database according to the music template, wherein the multimedia segment corresponding to each time period of each track comprises audio information obtained by a user playing a track melody corresponding to the time period of the track, and the database comprises a plurality of multimedia segments played by a plurality of users;
joining audio information in multimedia segments corresponding to respective time periods of each track respectively, to obtain a track audio corresponding to each track; and
generating target music by combining the track audio corresponding to respective tracks.

In a second aspect, an embodiment of the disclosure provides a method for generating music, comprising:
displaying a plurality of tracks of a music template, each track being divided into at least one time period, and the plurality of tracks being orchestrated tracks of the music;
in response to a selection operation for a first time period, displaying a multimedia recording page corresponding to the first time period, the first time period being any of time periods corresponding to the plurality of tracks; and
recording multimedia information within a recording time period corresponding to the multimedia recording page, to obtain a first multimedia segment corresponding to the first time period, and sending the first multimedia segment to a server.

In a third aspect, an embodiment of the disclosure provides an apparatus for generating music, comprising:
a determining module configured to determine a music template, the music template comprising a plurality of tracks, each track being divided into at least one time period, and the plurality of tracks being orchestrated tracks of music;
an acquiring module configured to acquire a multimedia segment corresponding to each time period of each track from a database according to the music template, wherein the multimedia segment corresponding to each time period of each track comprises audio information obtained by a user playing a track melody corresponding to the time period of the track, and the database comprises a plurality of multimedia segments played by a plurality of users;
a processing module configured to join audio information in multimedia segments corresponding to respective time periods of each track respectively, to obtain a track audio corresponding to each track; and
a generating module configured to generate target music by combining the track audio corresponding to respective tracks.

In a fourth aspect, an embodiment of the disclosure provides an apparatus for generating music, comprising:
a displaying module configured to display a plurality of tracks of a music template, each track being divided into at least one time period, and the plurality of tracks being orchestrated tracks of the music;
the displaying module configured to, in response to a selection operation for a first time period, display a multimedia recording page corresponding to the first time period, the first time period being any of the time periods corresponding to the plurality of tracks;
a generating module configured to record multimedia information within a recording time period corresponding to the multimedia recording page, to obtain a first multimedia segment corresponding to the first time period; and
a sending module configured to send the first multimedia segment to a server.

In a fifth aspect, an embodiment of the disclosure provides an electronic device, comprising: a processor and a memory;
the memory storing a computer execution instruction;
the processor executing the computer execution instruction to implement the method for generating music of the first aspect and its various possible implementations, or to implement the method for generating music of the second aspect and its various possible implementations.

In sixth aspect, an embodiment of the disclosure provides a computer readable storage medium having a computer execution instruction stored thereon, the computer execution instruction, when executed by a processor, implementing the method for generating music of the first aspect and its various possible implementations, or to implement the method for generating music of the second aspect and its various possible implementations.

In a seventh aspect, an embodiment of the disclosure provides a computer program product comprising a computer program, the computer program, when executed by a processor, implementing the method for generating music of the first aspect and its various possible implementations, or to implement the method for generating music of the second aspect and its various possible implementations.

In eighth aspect, an embodiment of this disclosure provides a computer program, when executed by a processor, implements the method for generating music of the first aspect and its various possible implementations, or to implement the method for generating music of the second aspect and its various possible implementations.

The embodiments of this disclosure provide a method, apparatus, device, storage medium, computer program product and computer program. The method comprises: determining a music template, the music template comprising a plurality of tracks, each track being divided into at least one time period; obtaining a multimedia segment corresponding to each time period of each track from a database according to the music template, wherein the multimedia segment corresponding to each time period of each track comprises audio information obtained by a user playing a track melody corresponding to the time period of the track, and the database comprises a plurality of multimedia segments played by a plurality of users; joining audio information in multimedia segments corresponding to respective time periods of each track respectively, to obtain a track audio corresponding to each track; and generating target music by combining the track audio corresponding to respective tracks. In the foregoing process, because respective media segment stored in the database is played by a plurality of users, target music generated by the server according to a multimedia segment in the database is generated by a plurality of users performing collaborative playing. By generating target music by collaborative playing of a plurality of users, the cooperation and interactivity between the users are enhanced, the interestingness of a user composing music or playing music is increased, and the user experience is improved.

### BRIEF DESCRIPTION OF THE DRAWINGS

To describe the technical solutions in the embodiments of the present disclosure or in the prior art more clearly, the following briefly introduces the accompanying drawings required for describing the embodiments or the prior art. The accompanying drawings in the following description show some embodiments of the present disclosure, other drawings may also be obtained by the skilled person according to these drawings without creative efforts.

FIG. 1 is a schematic diagram of music tracks and time periods according to an embodiment of the present disclosure;

FIG. 2 is a schematic diagram of an application scenario according to an embodiment of the present disclosure;

FIG. 3 is a flowchart of a method for generating music according to an embodiment of the present disclosure;

FIG. 4 is a schematic diagram of a group of display pages according to an embodiment of the present disclosure;

FIG. 5 is a schematic diagram of another group of display pages according to an embodiment of the present disclosure;

FIG. 6 is a schematic diagram of still another group of display pages according to an embodiment of the present disclosure;

FIG. 7 is a flowchart of another method for generating music according to an embodiment of the present disclosure;

FIG. 8 is a schematic diagram of still another display page according to an embodiment of the present disclosure;

FIG. 9 is a schematic diagram of a process for generating music according to an embodiment of the present disclosure;

FIG. 10 is a schematic diagram of a video template according to an embodiment of the present disclosure;

FIG. 11 is a schematic structural diagram of an apparatus for generating music according to an embodiment of the present disclosure;

FIG. 12 is a schematic structural diagram of another apparatus for generating music according to an embodiment of the present disclosure; and

FIG. 13 is a schematic structural diagram of an electronic device according to an embodiment of the present disclosure.

### DETAILED DESCRIPTION

In order to make objects, technical solutions and advantages of the embodiments of the present disclosure more apparent, the technical solutions in the embodiments of the present disclosure will be described below clearly and fully in connection with the drawings related to the embodiments of the present disclosure. Obviously, the described embodiments are only a part but not all of the embodiments of the present disclosure. All other embodiments obtained by persons of ordinary skill in the art based on the embodiments of the present disclosure without creative efforts shall belong to the scope of protection of the present disclosure.

At present, a method for a user to compose music or play music generally comprises: listening to a song and sing a song with karaoke. In a karaoke scene, a terminal device installs karaoke software, and plays background music of a music composition by the karaoke software. The user follows the background music to sing the song.

However, music itself is an artistic form with very strong interactivity and cooperation. The manners such as listening to a song and singing the song with karaoke are relatively monotonous, and lack of collaboration and interaction between users.

In order to solve the described technical problem, the present disclosure provides a method, apparatus, device, storage medium and program for generating music, which may generate target music by collaborative playing of a plurality of users. The manner of collaborative playing by a plurality of users refers to dividing a music template into a plurality of parts, playing one or more parts by each user, and combining the parts played by the plurality of users to obtain target music.

In the embodiment of the present disclosure, the music template comprising a plurality of tracks. The tracks in embodiments of this disclosure are orchestrated tracks of music. The track type corresponding to each track may be one of a melody track type, an accompaniment track type and a percussion track type. The melody track refers to a track corresponding to a sound of a singing lyrics, the accompaniment track may be a track corresponding to a sound of a musical instrument such as guitar, piano, erhu, and violin, and the percussion track may be a track corresponding to a sound of a percussion-type musical instrument such as a drum set or a hand drum.

The number of tracks included in the music template is not limited in the embodiment of the present disclosure. For example, some music templates include a melody track, a piano accompaniment track, a erhu accompaniment track, and a drum set track. Some music templates may include a melody track, a guitar accompaniment track, and a hand drum percussion track.

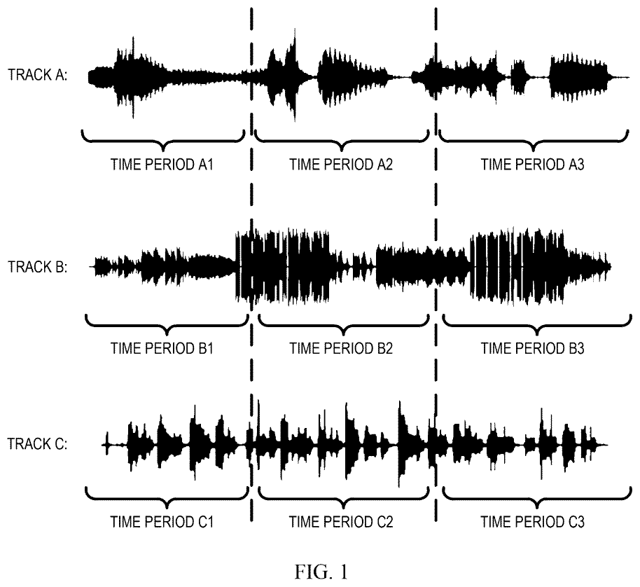

The manner of collaborative playing by a plurality of users is illustrated below with reference to FIG. 1.

FIG. 1 is a schematic diagram of music tracks and time periods according to an embodiment of the present disclosure. Referring to FIG. 1, assume that a music template comprises three tracks, respectively track A, track B, and track C. The target music may be generated by following collaboratively playing: the user 1 plays track A to obtain the multimedia information corresponding to the track A, the user 2 plays track B to obtain the multimedia information corresponding to the track B, and the user 3 plays track C to obtain the multimedia information corresponding to the track C. The multimedia information corresponding to track A, track B, and track C is combined to generate target music.

The multimedia information includes audio information and/or video information.

Further, with continued reference to FIG. 1, each track may be divided into a plurality of time periods from a time dimension. Each time period corresponds to a certain length of time, and different time periods do not overlap with each other. For example, it may be divided according to beat sequence, every 4 to 8 beats may be divided into one time period, or it may be divided according to time sequence, every 10 seconds may be divided into one time period. For example, in FIG. 1, track A is divided into three time periods, which are a time period A1, a time period A2, and a time period A3, respectively; track B is divided into three time periods, which are a time period B1, a time period B2, and a time period B3, respectively; and track C is divided into three time periods: a time period C1, a time period C2, and a time period C3.

In this way, the target music may be generated by the following collaborative playing: each user plays a part of the time period among the time period A1, the time period A2, the time period A3, the time period B1, the time period B2, the time period B3, the time period C1, the time period C2, and the time period C3 described above.

For example, the user 1 plays time period A1 to obtain a multimedia segment corresponding to the time period A1, the user 2 plays time period A2 to obtain a multimedia segment corresponding to the time period A2, and the user 3 plays time period A3 to obtain a multimedia segment corresponding to the time period A3, the user 4 plays time period B1 to obtain a multimedia segment corresponding to the time period B1, the user 4 plays time period B2 to obtain a multimedia segment corresponding to the time period B2, the user 5 plays time period B3 to obtain a multimedia segment corresponding to the time period B3, the user 6 plays time period C1 to obtain a multimedia segment corresponding to the time period C1, the user 7 plays time period C2 to obtain a multimedia segment corresponding to the time period C2, and the user 8 plays time period C3 to obtain a multimedia segment corresponding to the time period C3.

In addition, the multimedia segments corresponding to the time period A1, the time period A2, and the time period A3 are joined to obtain the multimedia information corresponding to track A; the multimedia segments corresponding to the time period B1, the time period B2, and the time period B3 are joined to obtain multimedia information corresponding to track B; and the multimedia segments corresponding to the time period C1, the time period C2, and the time period C3 are joined to obtain the multimedia information corresponding to track C. Further, the multimedia information corresponding to track A, track B, and track C is combined to generate target music.

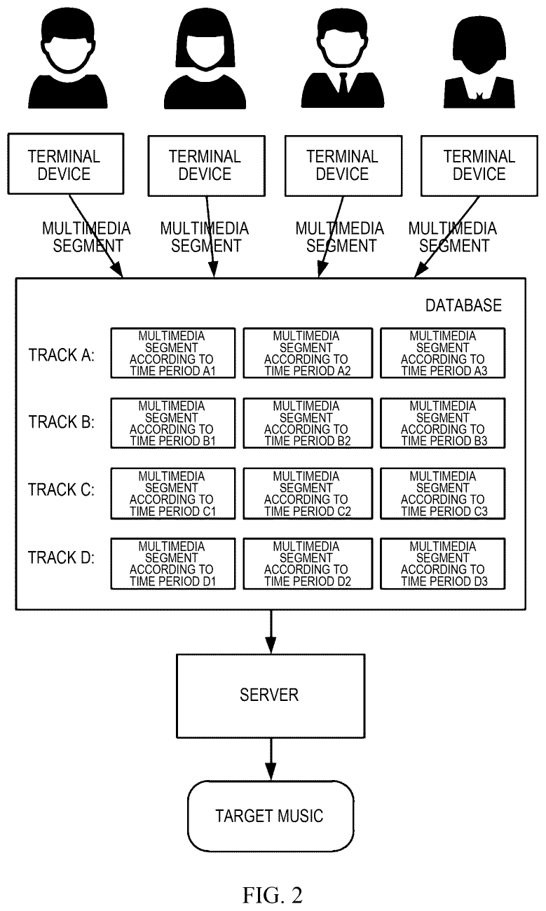

To facilitate understanding of the technical solutions of the present disclosure, an application scenario of the embodiments of the present disclosure is described below with reference to FIG. 2.

FIG. 2 is a schematic diagram of an application scenario according to an embodiment of the present disclosure. As shown in FIG. 2, the application scenario includes a terminal device, a database and a server. The terminal device may be any electronic device having a multimedia interaction function, including, but not limited to, a smartphone, a tablet computer, a notebook computer, a smart television, a smart wearable device, a smart home device, a smart vehicle-mounted device, a smart speaker, and the like. In the subsequent figures, when a display page of a terminal device is illustrated, a mobile phone page is taken as an example for illustration. A server may be a cloud server, which is also referred to as a cloud computing server or a cloud host, and is a host product in a cloud computing service system. The server may also be a server of a distributed system, or a server combined with a block chain.

The method for generating music provided in this embodiment may include two processes: a process of generating a multimedia segment and a process of generating target music. The process of generating the multimedia segment may be executed by a terminal device, and the process of generating the target music may be executed by a server. The foregoing two processes are described separately in the following with reference to FIG. 1.

As shown in FIG. 2, in a process of generating a multimedia segment, a plurality of users may be involved. Each user may obtain one or more multimedia segments by recording through a terminal device. For example, each user may select to play a certain time period in a certain track, and record a playing process to obtain a multimedia segment. The terminal device uploads the multimedia segments to a database. The database stores the multimedia segments corresponding to respective time periods in respective tracks.

Still referring to FIG. 2, in the process of generating the target music, the server may obtain the multimedia segments corresponding to respective time periods in respective track from the database, and combines the multimedia segments to generate the target music.

As shown in FIG. 2, in an application scenario of the disclosure, each multimedia segment stored in a database is played by a plurality of users. Therefore, the target music generated by a server according to the multimedia segments in the database is generated by a plurality of users playing collaboratively.

In the technical solutions of the present disclosure, target music is generated by collaborative playing of a plurality of users, thereby enhancing the cooperation and interactivity between the users, increasing the interestingness of a user composing music or playing music, and improving the user experience. Meanwhile, a user generated content (UGC) may also be enriched, to facilitate the popularization and propagation of music playing.

The technical solutions of the present disclosure will be described in detail below with reference to specific embodiments. The following several specific embodiments may be combined with each other, and the same or similar concepts or processes may not be repeated in some embodiments.

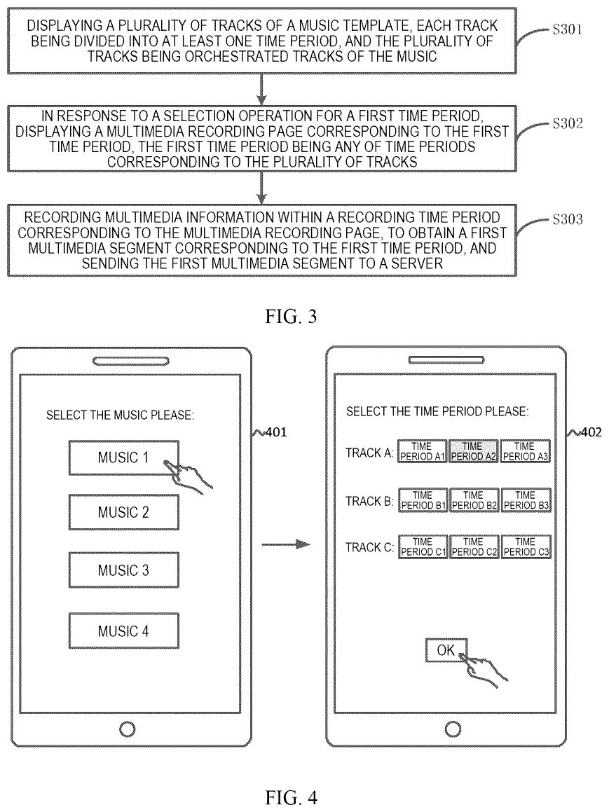

FIG. 3 is a schematic flowchart of a method for generating music according to an embodiment of the present invention. The method in this embodiment may be executed by a terminal device. This embodiment describes a process of generating a multimedia segment. As shown in FIG. 3, the method in this embodiment comprises:

S301: displaying a plurality of tracks of a music template, each track being divided into at least one time period, and the plurality of tracks being orchestrated tracks of the music.

In this embodiment, the music template may also be referred to as music to be played. Before the terminal device executes this embodiment, the music template is divided into a plurality of tracks, and each track is divided into a plurality of time periods. The terminal device may display a selection page for the user to choose which time period in which track to play.

In an example, FIG. 4 is a schematic diagram of a group of display pages according to an embodiment of the present disclosure. As shown in FIG. 4, the terminal device displays a page 401, and displays a plurality of pieces of music in the page 401. The user may choose one piece of music from the page 401 for playing, where the music chosen by the user is used as a music template. Referring to FIG. 4, in response to a selection operation of ‘music 1’ by a user, a terminal device displays a selection page corresponding to ‘music 1’, i.e., page 402 in which a plurality of tracks included in the music 1 are displayed, and each track is divided into at least one time period.

It should be understood that, the number of tracks included in the music template and the number of time periods included in each track are not limited in this embodiment. FIG. 4 is a schematic diagram of an example in which the music 1 comprises three tracks, and each track comprises three time periods.

In the page 402, the user may not accurately determine which part of the target music corresponding to the time period according to the time period identifier. Therefore, in some possible implementations, when a user selects an identifier of a time period, description information corresponding to the time period may also be displayed in the page 402, for example, lyrics, musical notes, time intervals, and the like. In an example, when an identifier of a time period is selected, the identifier of the time period is replaced and displayed as the description information corresponding to the time period. In this way, the user may accurately know, according to the description information of the time period, specific content to be played, which facilitates selection of the user.

With continued reference to FIG. 4, in the page 402, the user may select, according to his/her own wishes, one of the time periods to play. For example, assuming that the user wants to play a time period A2 corresponding to track A, after the user selects the time period A2 corresponding to track A and clicks the determination control, the terminal device is triggered to perform S302 of this embodiment.

In this embodiment, each track is divided into a plurality of time periods, so that a user may select one time period to play, thereby reducing difficulty in playing for the user. Of course, in practical applications, the user may select a plurality of time periods for playing.

S302: in response to a selection operation for a first time period, displaying a multimedia recording page corresponding to the first time period, the first time period being any of time periods corresponding to the plurality of tracks.

S303: recording multimedia information within a recording time period corresponding to the multimedia recording page, to obtain a first multimedia segment corresponding to the first time period, and sending the first multimedia segment to a server.

In this embodiment, the time period selected by the user is referred to as a first time period, and the first time period may be any time period in the page 402. For example, if the user selects the time period A2 corresponding to track A in the page 402 of FIG. 4, the time period A2 corresponding to track A is the first time period.

In this embodiment, after detecting that a user selects a first time period, a terminal device displays a multimedia recording page corresponding to the first time period, and the user may record multimedia information in the multimedia recording page. For example, a user may play music content corresponding to a first time period. As an example, if the first time period corresponds to a melody track, the user sings lyrics corresponding to the first time period; if the first time period corresponds to a piano accompaniment track, the user plays a piano melody corresponding to the first time period; and if the first time period corresponds to a guitar accompaniment track, the user plays a guitar melody corresponding to the first time period. Further, while playing, the user records his own playing process by a terminal to obtain the first multimedia segment corresponding to the first time period.

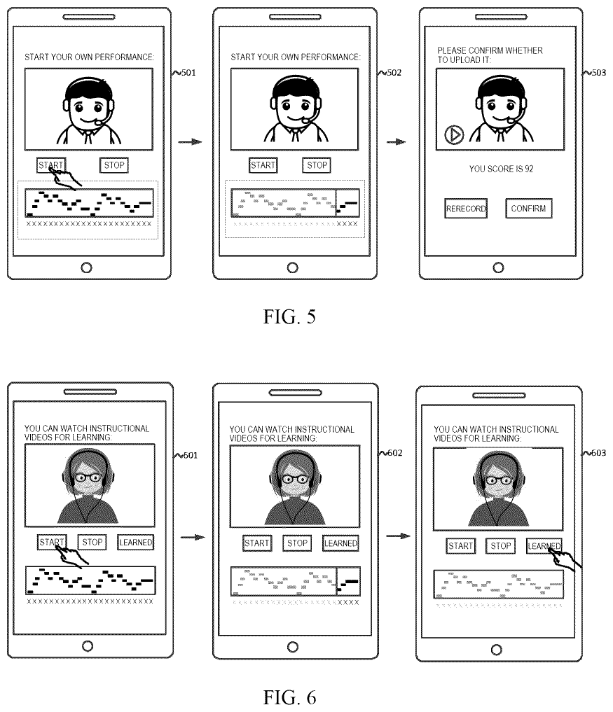

FIG. 5 is a schematic diagram of another group of display pages according to an embodiment of the present disclosure. For example, after the user selects the time period A2 of the track A from the page 402 shown in FIG. 4 and clicks the determination control, the terminal device may display the page 501 shown in FIG. 5. The page 501 is a multimedia recording page, and a user may record multimedia information in the page 501 to generate a multimedia segment.

In some possible implementations, the multimedia recording page comprises a start control and a stop control. In response to a click operation on the start control, the terminal device starts recording the multimedia information until a click operation on the stop control is received or the recording of the multimedia information is stopped at an end time of the recording time period, to obtain the first multimedia segment.

In some possible implementations, the multimedia recording page further comprises an information prompt region. During recording multimedia information, the terminal device obtains a recording progress of the multimedia information; displays prompt information in the information prompt region according to the recording progress, wherein the prompt information comprises at least one of lyrics and a musical note. For example, in FIG. 5, what is marked by the dotted box in the page 501 is an information prompt region. In the information prompt area, lyrics (represented by XXX) and musical notes (represented by a waveform formed by a black rectangular box) are displayed.

The following describes the recording process of the multimedia information in detail with reference to FIG. 5.

Referring to FIG. 5, after the user clicks the start control in the page 501, the user starts to play the first time period, and records a playing process by the audio collecting apparatus and/or the video collecting apparatus of the terminal device. The recording process is shown in a page 502. In the recording process, information such as a lyrics and a musical note to be played currently may be prompted in the information prompt region. After recording is completed, a first multimedia segment corresponding to a first time period is obtained. The terminal device displays a page 503, and a user may play back and view the first multimedia segment in the page 503, and determine whether to upload the first multimedia segment to a server.

Optionally, after the terminal device obtains the first multimedia segment by recording, the terminal device may further determine the similarity between the first multimedia segment and the original music piece, and determine a score corresponding to the first multimedia segment according to the similarity, which is shown in the page 503. In this way, the user may determine, according to the score, whether to rerecord. If the user clicks to rerecord, the terminal device displays a page 501, so that the user restarts recording. If the user clicks OK, the terminal device sends the first multimedia segment to the server.

In this embodiment, after receiving the first multimedia segment, the server stores the first multimedia segment in the database.

It should be understood that, this embodiment describes a process of generating a multimedia segment. With respect to each time period displayed in the page 402, multimedia segments corresponding to each time period may be generated in the manner in this embodiment. In practice, the plurality of time periods displayed in the page 402 may be played by a plurality of users, and each user plays one or more of the time periods.

In this embodiment, target music is generated by collaborative playing of a plurality of users, thereby enhancing the cooperation and interactivity between the users, increasing the interestingness of the users in composing music or playing music, and improving the user experience.

Further, in this embodiment, a plurality of users use an ‘asynchronous collaboration’ manner, so that it is unnecessary for the plurality of users to play simultaneously, thereby reducing difficulty in collaboration between the plurality of users. In addition, the problem that users cannot collaborate together is avoided.

In addition, considering that the user may know little music knowledge, play no musical instrument, or has no confidence in this performance level, these factors may reduce the interest of the user in playing music. Therefore, in this embodiment, the following possible manners may also be used to reduce difficulty in playing for the user.

In some possible implementations, a collaboration manner of acapella may be adopted, where acapella is an unaccompanied choir that sings in a human voice and does not use musical instruments. Specifically, a candidate song (e.g., a song with adaptation rights, or a song composed by user himself) is adapted in advance to the form of acapella. The adapted song has a plurality of tracks, and each track is in the form of acapella. When playing each track, a user plays each track in human voice. In this way, even if the user does not play musical instruments, the user may participate in the collaboration among multiple people, thereby reducing the difficulty in playing music.

In other possible implementations, a teaching video may be recorded in advance for each time period. In the teaching video, a professional may demonstrate the singing of the time period, or the professional introduces a singing caution item for describing the time period, so as to help the user to know the correct pitch and rhythm. The process of using the teaching videos is described below with reference to FIG. 6.

FIG. 6 is a schematic diagram of still another group of display pages according to an embodiment of the present disclosure. For example, after the user selects the time period A2 of the track A in the page 402 shown in FIG. 4 and clicks the confirmation control, the terminal device may display the page 601 shown in FIG. 6 first. The page 601 is a teaching video page. In the page 601, the user may click the start control to start playing the teaching video corresponding to the first time period. Similar to the multimedia recording page shown in FIG. 5, the teaching video page may include an information prompt region. In the process of playing the teaching video, the information prompt information may display prompt information such as lyrics and characters. The process of playing the teaching video is as shown in a page 602.

The user may obtain key points such as pitch and rhythm corresponding to the first time period from learning the teaching video learning. It should be understood that the user may watch the teaching video repeatedly. As shown in a page 603, after a user learns, the user may click a ‘learned’ control, so as to trigger the terminal device to display a page 501 shown in FIG. 5, and start a multimedia recording process.

In this embodiment, by providing the user with the teaching videos corresponding to each time period, the user may first learn and then play, thereby further reducing the difficulty of playing for the user.

The foregoing embodiments describe a process of generating a multimedia segment corresponding to one time period of target music. It should be understood that, after the multimedia segments corresponding to all time periods in the target music are generated, the multimedia segments corresponding to the respective time periods may be combined to generate the target music. The following describes how to combine a plurality of multimedia segments to generate target music in detail with reference to several embodiments.

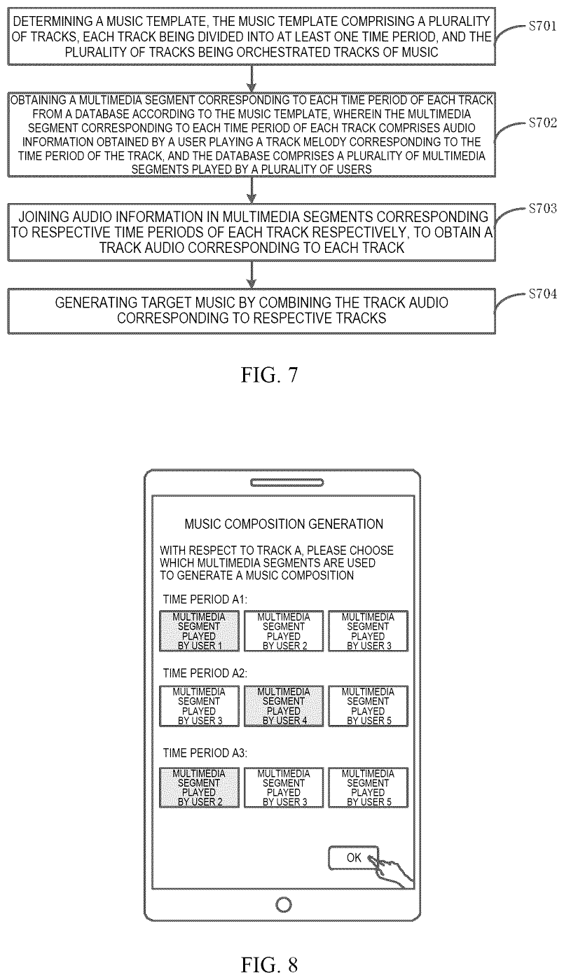

FIG. 7 is a flowchart of another method for generating music according to an embodiment of the present disclosure. The method of this embodiment may be executed by a server. This embodiment describes a process of generating target music. As shown in FIG. 7, the method in this embodiment comprises:

S701: determining a music template, the music template comprising a plurality of tracks, each track being divided into at least one time period, and the plurality of tracks being orchestrated tracks of music.

When the execution time of this embodiment is that the server determines that the target music needs to be generated according to the music template, there are following two trigger manners.

Manner 1: a server automatically triggers. For example, when the server detects that collection of a multimedia segments corresponding to a music template is completed, the server triggers execution of this embodiment. For example, assume that a music template comprises three tracks, respectively track A, track B, and track C; and track A is divided into three time periods, respectively time period A1, time period A2 and time period A3; track B is divided into three time periods, respectively time period B1, time period B2, and time period B3; track C is divided into three time periods, respectively time period C1, time period C2, and time period C3. When the collection of multimedia segments corresponding to above time period A1, time period A2, time period A3, time period B1, time period B2, time period B3, time period C1, time period C2, time period C3 is completed, the method of this embodiment may be executed to generate target music.

Manner 2: a user manually triggers. For example, in the page 401 shown in FIG. 4, the terminal device may further display the play information corresponding to each time period, for example, whether the time period has been played. If the time period has been played, it indicates that multimedia segment corresponding to the time period already exists in the server. If the user determines, according to the play information of each time period displayed on the page 401, that each time period in the target music has been played, the process of generating target music may be triggered manually. For example, after a terminal device detects that a user combines the music, the terminal device sends a music generation request to a server. After receiving the music generation request, the server executes the method of this embodiment.

S702: obtaining a multimedia segment corresponding to each time period of each track from a database according to the music template, wherein the multimedia segment corresponding to each time period of each track comprises audio information obtained by a user playing a track melody corresponding to the time period of the track, and the database comprises a plurality of multimedia segments played by a plurality of users.

It should be understood that each multimedia segment in the database may be generated by using the embodiment shown in FIG. 3. Each multimedia segment stored in the database may be played and uploaded by a plurality of users. That is, the database includes a plurality of multimedia segments played by a plurality of users. For example, ten multimedia segments are stored in the database, where a part of the multimedia segments is played and uploaded by the user 1, another part of the multimedia segments is played and uploaded by the user 2, and yet another part of the multimedia segments is played and uploaded by the user 3.

A multimedia segment corresponding to each time period of each track may be obtained according to the music template, so that the multimedia segment required to generate target music is obtained.

The multimedia segment corresponding to each time period of each track comprises audio information obtained by a user playing a track melody corresponding to the time period of the track. The playing manner by user for the track melody corresponding to each time period of each track may refer to the related description in the foregoing embodiment, and details are not described herein again.

In this embodiment, when storing the multimedia segment, the database may record the relation between the music template, track, time period and the multimedia segment. In an example, content stored in the database is shown in Table 1. In this way, the server may acquire, according to a plurality of tracks included in the music template and time periods corresponding to each track, a multimedia segment required for generating the target music from the database.

TABLE 1

| music | | | |
|---|---|---|---|
| module | track | time period | multimedia segment |
| music 1 | track A | time period A1 | multimedia segment |
| | | | corresponding to time |
| | | | period A1 |
| | | time period A2 | multimedia segment |
| | | | corresponding to time |
| | | | period A2 |
| | | time period A3 | multimedia segment |
| | | | corresponding to time |
| | | | period A3 |
| | track B | time period B1 | multimedia segment |
| | | | corresponding to time |
| | | | period B1 |
| | | time period B2 | multimedia segment |
| | | | corresponding to time |
| | | | period B2 |
| | | time period B3 | multimedia segment |
| | | | corresponding to time |
| | | | period B3 |
| | track C | time period C1 | multimedia segment |
| | | | corresponding to time |
| | | | period C1 |
| | | time period C2 | multimedia segment |
| | | | corresponding to time |
| | | | period C2 |
| | | time period C3 | multimedia segment |
| | | | corresponding to time |
| | | | period C3 |
| . . . | . . . | . . . | . . . |

In some possible scenarios, a certain time period may be played by a plurality of users, and therefore a database may store a plurality of multimedia segments corresponding to the time period. For this case, the following two implementations are possible.

In a possible implementation, if the server triggers a process of generating the target music, the server may determine, according to attribute information of a plurality of multimedia segments corresponding to a time period, one multimedia segment among the plurality of multimedia segments to generate the target music. The attribute information may include at least one of: player information, score, uploading time, ranking, and popularity value.

For example, as for each time period, if the time period corresponds to a plurality of multimedia segments, the server may select a first-ranked multimedia segment, or select a multimedia segment with the highest popularity value, or select the most recently uploaded multimedia segment, or select a multimedia segment with the highest score, or select a multimedia segment played by a certain designated player.

In another possible implementation, if the user manually triggers the process of generating the target music, the user may specify, from a plurality of multimedia segments corresponding to a time period, which multimedia segment is used to generate the target music.

For example, FIG. 8 is a schematic diagram of still another display page provided in an embodiment of the present disclosure. As shown in FIG. 8, an example is a music composition generation page, in which a plurality of multimedia segments respectively played by a plurality of users corresponding to a time period A1, a plurality of multimedia segments respectively played by a plurality of users corresponding to a time period A2, and a plurality of multimedia segments respectively played by a plurality of users corresponding to a time period A3 are displayed. The user may select which multimedia segments are used to generate the target music in the page shown in FIG. 8. For example, the user may select a multimedia segment corresponding to the time period A1 played by the user 1, a multimedia segment corresponding to the time period A2 played by the user 4, and a multimedia segment corresponding to the time period A3 played by the user 2. In this way, the server uses the three multimedia segments as the multimedia segments corresponding to track A.

It should be understood that, FIG. 8 is illustrated by taking track A as an example, and a similar implementation may be used for other tracks.

S703: joining audio information in multimedia segments corresponding to respective time periods of each track respectively, to obtain a track audio corresponding to each track.

S704: generating target music by combining the track audio corresponding to respective tracks.

For example, taking track A as an example, assuming that track A comprises three time periods, which are time period A1, time period A2, and time period A3, the multimedia segment corresponding to time period A1, the multimedia segment corresponding to time period A2, and the multimedia segment corresponding to time period A3 may be joined to obtain the track audio corresponding to track A. The processing of the track B and the track C is similar to that of the track A, and is not repeated herein.

In a possible implementation, in S703, as for each track, the following processing manner may be adopted: determining a track type of the track, the track type including a melody track type, an accompaniment track type or a percussion track type. According to the track type of the track, the audio information in at least one multimedia segments corresponding to the track is processed to obtain the track audio corresponding to the track. That is, different track types may correspond to different processing manners, so as to satisfy the sound effect characteristics of different tracks and improve the effect of target music. A specific processing manner for each track is not limited herein, and reference may be made to detailed description in subsequent embodiments.

Further, track audio corresponding to track A, track audio corresponding to track B, and track audio corresponding to track C are combined to generate target music.

The method for generating music provided in the present embodiment comprises: determining a music template, the music template comprising a plurality of tracks, each track being divided into at least one time period, and the plurality of tracks being orchestrated tracks of music; obtaining a multimedia segment corresponding to each time period of each track from a database according to the music template, wherein the multimedia segment corresponding to each time period of each track comprises audio information obtained by a user playing a track melody corresponding to the time period of the track, and the database comprises a plurality of multimedia segments played by a plurality of users; joining audio information in multimedia segments corresponding to respective time periods of each track respectively, to obtain a track audio corresponding to each track; and generating target music by combining the track audio corresponding to respective tracks. In the foregoing process, because each media segment stored in the database is played by a plurality of users, target music generated by the server according to a multimedia segment in the database is generated by a plurality of users performing collaborative playing. By generating target music by collaborative playing of a plurality of users, the cooperation and interactivity between the users are enhanced, the interestingness of a user in creating music or playing music is increased, and the user experience is improved.

Based on the embodiment shown in FIG. 7, the technical solution of the present disclosure will be described below in more detail with reference to a specific embodiment.

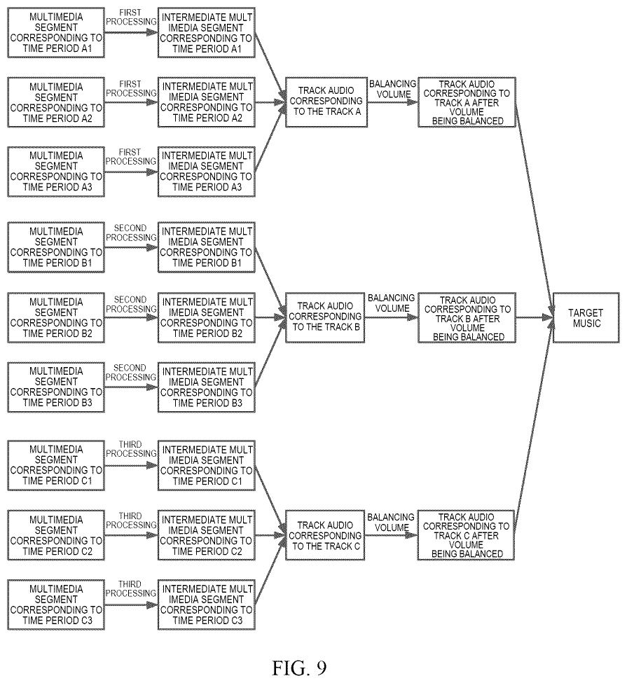

FIG. 9 is a schematic diagram of a method for generating music according to an embodiment of the present disclosure. As shown in FIG. 9, assume that the target music comprises track A, track B, and track C. The track type of the track A is a melody track type, the track type of the track B is an accompaniment track type, and the track type of the track C is a percussion track type. The track A is divided into three time periods, respectively time period A1, time period A2, and time period A3; the track B is divided into three time periods, respectively time period B1, time period B2, and time period B3; and the track C is divided into three time periods, respectively time period C1, time period C2, and time period C3.

In this embodiment, the server obtains multimedia segments corresponding to the time period A1, the time period A2, the time period A3, the time period B1, the time period B2, the time period B3, the time period C1, the time period C2, and the time period C3. The server performs the following processing on the multimedia segment to generate target music.

(1) for track A, performing first processing on audio information in a multimedia segment corresponding to each time period of the track A, to obtain an intermediate multimedia segment corresponding to the time period, and joining the audio information in the intermediate multimedia segments corresponding to the respective time periods of the track A to obtain the track audio corresponding to the track A.

the first processing comprising at least one of: high-pitch correcting processing and reverberation adding processing.

In this embodiment, the pitch correcting processing refers to correcting the pitch of the audio information in the multimedia segment according to the pitch of the original music corresponding to the music template, to enable the audio information in the multimedia segment more consistent with the original music. The reverberation adding processing refers to adding an reverberation effect to audio information in a multimedia segment, to enable an audio signal to have a better sense of space. Reverberation is an acoustic phenomenon in which sound continues to exist and rebound after the sound source stops producing sound in a space.

In this embodiment, the performance effect of the generated target music can be improved by performing the pitch correcting processing and/or the reverberation adding processing on the melody tracks.

(2) for track B, performing second processing on audio information in a multimedia segment corresponding to each time period of the track B, to obtain an intermediate multimedia segment corresponding to the time period; and joining the audio information in the intermediate multimedia segments corresponding to the respective time periods of the track A to obtain the track audio corresponding to the track.

The second processing comprising at least one of: high-pitch correcting processing, reverberation adding processing, and low-frequency enhancing processing.

In this embodiment, for an accompaniment track, since effective sound of the accompaniment track is mainly in a low frequency part, in addition to performing pitch correcting processing and reverberation adding processing on the accompaniment track, low-frequency enhancing processing may also be performed on the accompaniment track. That is, the loudness of a low frequency part of audio information in a multimedia segment is enhanced, so that the accompaniment is thicker, and the whole target music piece may be supported.

(3) for track C, performing third processing on audio information in a multimedia segment corresponding to each time period of the track C, to obtain an intermediate multimedia segment corresponding to the time period; and joining the audio information in the intermediate multimedia segments corresponding to the respective time periods of the track C to obtain the track audio corresponding to the track C.

The third processing comprising at least one of: high-pass filtering processing and reverberation adding processing.

In the present embodiment, for a percussion track, since effective sound of the percussion track is mainly at a high frequency portion, high frequency filtering processing may be performed on the percussion track to eliminate low frequency noise, so that the sound at the high frequency portion is more clearly distinguishable. In addition, reverberations may also be added to the percussion track, so that percussion track sound effects have a better sense of space.

(4) determining a predetermined volume corresponding to the music template; balancing volume of the track audio corresponding to each track according to the predetermined volume, to obtain the track audio with balanced volume corresponding to track A, the track audio with balanced volume corresponding to track B, and the track audio with balanced volume corresponding to track C.

In practice, because each multimedia segment is played by a plurality of users, different users may have different volumes during playing. In order to avoid disharmony of the whole target music caused by too large or too small volume of some users, in this embodiment, volume balance processing may be performed on the track audio corresponding to each track, so that the track volume corresponding to each track is relatively balanced.

It can be understood that, in this embodiment, volume balancing processing is performed on track audio corresponding to each track, so that volume of each track is relatively balanced on the one hand, and volume of each time period in the same track is also relatively balanced on the other hand.

Optionally, the volume of the original music corresponding to the music template may be determined as the predetermined volume, so that the performance effect of the target music generated in this embodiment is more inclined to the performance effect of the original music.

(5) combining and noise-reducing the track audio corresponding to track A after the volume being balanced, the track audio corresponding to track B after the volume being balanced and the track audio corresponding to track C after the volume being balanced, to obtain the target music.

In this embodiment, track audios of each track may be combined first to obtain combined audios, and then noise reduction processing is performed on the combined audios to obtain target music. In addition, the noise reduction processing may be separately performed on the track audio of each track to obtain the noise reduction frequency corresponding to each track, and then the noise reduction frequency corresponding to each track is combined to obtain the target music. By performing noise reduction processing, the background noise in the target music may be eliminated, and the playing effect of the target music can be improved.

In the embodiments shown in FIGS. 7 and 9, a multimedia segment includes audio information, and target music is generated by combining the audio information in the multimedia segment. The target music is music in an audio form. In some possible implementations, when a user records a multimedia segment, in addition to recording audio information, video information may also be synchronously recorded. That is to say, the multimedia segment includes audio information and video information. In this way, the video information in each multimedia segment may be combined to generate a target video corresponding to target music. Thus, the user can synchronously play the target music and the corresponding target video, and watch the multi-person cooperative playing through the target video, thereby further increasing the interestingness of music playing.

For example, a target video corresponding to target music may be generated by using the following method: obtaining a video template and a play time of each multimedia segment, the video template comprising a video window corresponding to each track; determining at least one multimedia segment corresponding to each video window; with respect to any video window, according to the play time of the at least one multimedia segment corresponding to the video window, connecting the video information in the multimedia segment corresponding to the video window serially, to obtain a track video corresponding to the video window; and adding the track video corresponding to each video window to the corresponding video window respectively, to obtain a target video corresponding to the target music.

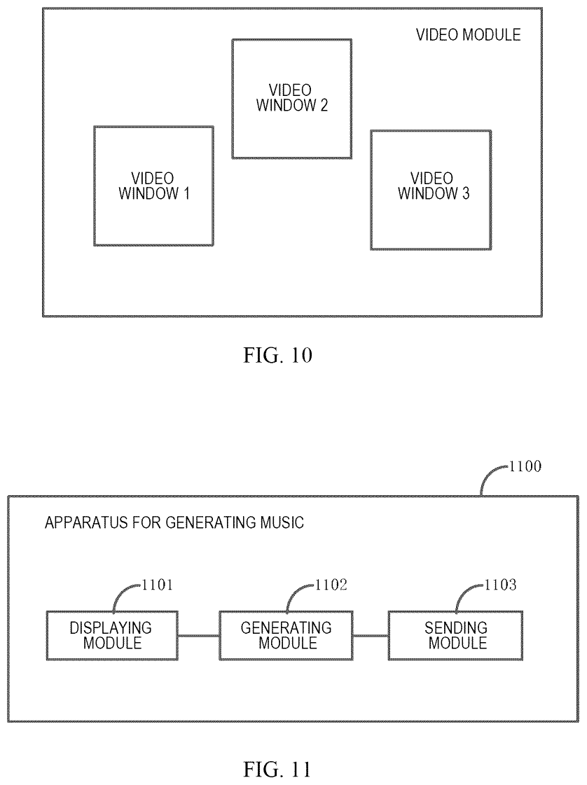

In an example, FIG. 10 is a schematic diagram of a video template according to an embodiment of the present disclosure. As shown in FIG. 10, the video template comprises three video windows, and each video window is used to play a track video corresponding to one track. For example, window 1 is used to play a track video corresponding to track A, window 2 is used to play a track video corresponding to track B, and window 3 is used to play a track video corresponding to track C.

Specifically, when a target video is generated, video information in at least one multimedia segment corresponding to track A is connected serially according to a sequence of each time period of track A to obtain a track video corresponding to track A, and the track video corresponding to track A is associated with window 1 for playing. Video information in at least one multimedia segment corresponding to track B is connected serially according to a sequence of each time period of track B to obtain a track video corresponding to track B and the track video corresponding to track B is associated with window 2 for playing. Video information in at least one multimedia segment corresponding to track C is connected serially according to a sequence of each time period of track C to obtain a track video corresponding to track C, and the track video corresponding to track C is associated with window 3 for playing.

Optionally, the video template may further comprise at least one of: head, tail, transition effect, and the like. When the target video is generated, a head may be added at the beginning of the target music, a tail may be added at the end of the target music, and a transition effect may be added when switching between time periods, thereby improving the effect of the target video.

In this embodiment, after generating the target music and the target video corresponding to the target music, the server may send the target music and the target video to a terminal device. In this way, the terminal device may synchronously play target music and a target video, so that a user may watch an effect of multi-person collaborative playing, thereby further increasing the interestingness of music playing.

FIG. 11 is a schematic structural diagram of an apparatus for generating music according to an embodiment of the present invention. The apparatus may be in a form of software and/or hardware. The apparatus may be a terminal device, or a processor, a chip, a chip module, a module, a unit, an application program, or the like integrated into the terminal device.

As shown in FIG. 11, an apparatus 1100 for generating music provided in this embodiment comprises: a displaying module 1101, a generating module 1102, and a sending module 1103.

The displaying module 1101 is configured to display a plurality of tracks of a music template, each track being divided into at least one time period, and the plurality of tracks being orchestrated tracks of the music;

the displaying module 1101 is further configured to, in response to a selection operation for a first time period, display a multimedia recording page corresponding to the first time period, the first time period being any of the time periods corresponding to the plurality of tracks;

The generating module 1102 is configured to record multimedia information within a recording time period corresponding to the multimedia recording page, to obtain a first multimedia segment corresponding to the first time period; and

The sending module 1103 is configured to send the first multimedia segment to a server.

In a possible implementation, the multimedia recording page comprises a start control and a stop control; the generating module 1102 is specifically configured for:
in response to a click operation on the start control, starting recording the multimedia information until a click operation on the stop control is received or the recording of the multimedia information is stopped at an end time of the recording time period, to obtain the first multimedia segment.

In a possible implementation, the multimedia recording page further comprises an information prompt region; the displaying module 1101 is configured for:
obtaining a recording progress of the multimedia information;
displaying prompt information in the information prompt region according to the recording progress, the prompt information comprising at least one of lyrics and a musical note.

The apparatus for generating music provided in this embodiment may be used to execute a method for generating music performed by a terminal device in any of the foregoing method embodiments, and implementation principles and technical effects of are similar, which are not described herein again.

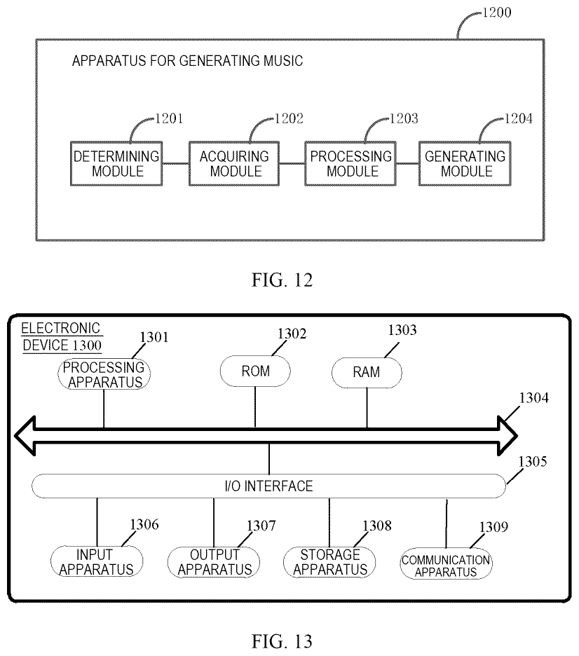

FIG. 12 is a schematic structural diagram of another apparatus for generating music according to an embodiment of the present invention. The apparatus may be in a form of software and/or hardware. The apparatus may be a server, or a processor, a chip, a chip module, a module, a unit, an application program, or the like integrated into the server.

As shown in FIG. 12, an apparatus 1200 for generating music provided in this embodiment comprises: a determining module 1201, an acquiring module 1202, a processing module 1203, and a generating module 1204.

The determining module 1201 is configured to determine a music template, the music template comprising a plurality of tracks, each track being divided into at least one time period, and the plurality of tracks being orchestrated tracks of music;

The acquiring module 1202 is configured to acquire a multimedia segment corresponding to each time period of each track from a database according to the music template, wherein the multimedia segment corresponding to each time period of each track comprises audio information obtained by a user playing a track melody corresponding to the time period of the track, and the database comprises a plurality of multimedia segments played by a plurality of users;

The processing module 1203 is configured to join audio information in multimedia segments corresponding to respective time periods of each track respectively, to obtain a track audio corresponding to each track; and

The generating module 1204 is configured to generate target music by combining the track audio corresponding to respective tracks.

In a possible implementation, for any track in the plurality of tracks, the processing module 1203 is specifically configured for:
determining a track type of the track, the track type including a melody track type, an accompaniment track type or a percussion track type; and
joining, according to the track type of the track, the audio information in the multimedia segments corresponding to the respective time periods of the track to obtain the track audio corresponding to the track.

In a possible implementation, the track type is a melody track type, and joining, according to the track type of the track, the processing module 1203 is specifically configured for:
performing first processing on audio information in a multimedia segment corresponding to each time period of the track respectively, to obtain an intermediate multimedia segment corresponding to the time period, the first processing comprising at least one of: high-pitch correcting processing and reverberation adding processing; and
joining the audio information in the intermediate multimedia segments corresponding to the respective time periods of the track to obtain the track audio corresponding to the track.

In a possible implementation, the track type is an accompaniment track type, and the processing module 1203 is specifically configured for:
performing second processing on audio information in a multimedia segment corresponding to each time period of the track respectively, to obtain an intermediate multimedia segment corresponding to the time period, the second processing comprising at least one of: high-pitch correcting processing, reverberation
joining the audio information in the intermediate multimedia segments corresponding to the respective time periods of the track to obtain the track audio corresponding to the track.

In a possible implementation, the track type is a percussion track type; the processing module 1203 is specifically configured for:
performing third processing on audio information in a multimedia segment corresponding to each time period of the track respectively, to obtain an intermediate multimedia segment corresponding to the time period, the third processing comprising at least one of: high-pass filtering processing and reverberation adding processing; and
joining the audio information in the intermediate multimedia segments corresponding to the respective time periods of the track to obtain the track audio corresponding to the track.

In a possible implementation, the generating module 1204 is specifically configured for:
determining a predetermined volume corresponding to the music template;
balancing volume of the track audio corresponding to each track according to the predetermined volume; and
combining and noise-reducing the track audio of the respective tracks after the volume being balanced to obtain the target music.

In a possible implementation, the multimedia segment further comprises video information; the acquiring module 1202 is further configured for: obtaining a video template and a play time of each multimedia segment, the video template comprising a video window corresponding to each track;
the processing module 1203 is further configured for: determining at least one multimedia segment corresponding to each video window; with respect to any video window, according to the play time of the at least one multimedia segment corresponding to the video window, connecting the video information in the multimedia segment corresponding to the video window serially, to obtain a track video corresponding to the video window; and
the generating module 1204 is further configured for: adding the track video corresponding to each video window to the corresponding video window respectively, to obtain a target video corresponding to the target music.

In a possible implementation, the apparatus further comprises:
a sending module, configured for sending the target music and the target video to a terminal device.

The apparatus for generating music provided in this embodiment may be used to execute a method for generating music performed by a server in any of the foregoing method embodiments, and implementation principles and technical effects are similar, which are not described herein again.

In order to realize the described embodiments, the embodiments of the present disclosure further provide an electronic device.

Referring to FIG. 13, it shows a schematic structural diagram of an electronic device 1300 suitable for implementing an embodiment of the present disclosure. The electronic device 1300 may be a terminal device or a server. The terminal device may include, but is not limited to, a mobile terminal such as a mobile phone, a notebook computer, a digital broadcast receiver, a personal digital assistant (PDA), a portable android device (PAD), a portable multimedia player (PMP), a vehicle-mounted terminal (for example, a vehicle-mounted navigation terminal), and the like, and a fixed terminal such as a digital TV, a desktop computer, and the like. The electronic device shown in FIG. 13 is merely an example and should not bring any limitation to the functions and scope of use of the embodiments of the present disclosure.

As shown in FIG. 13, the electronic device 1300 may include processing apparatus (e.g., central processing unit, graphics processing unit, etc.) 1301 that may perform various suitable actions and processes in accordance with a program stored in read only memory (ROM) 1302 or a program loaded into random access memory (RAM) 1303 from storage apparatus 1308. In the RAM 1303, various programs and data necessary for the operation of the electronic device 1300 are also stored. The processing apparatus 1301, the ROM 1302, and the RAM 1303 are connected to each other via a bus 1304. An input/output (I/O) interface 1305 is also connected to the bus 1304.

In general, the following apparatus may be connected to the I/O interface 1305: an input apparatus 1306 including, for example, a touch screen, a touch pad, a keyboard, a mouse, a camera, a microphone, an accelerometer, a gyroscope, or the like; an output apparatus 1307 including, for example, a liquid crystal display (LCD), a speaker, a vibrator, or the like; a storage apparatus 1308 including, for example, a magnetic tape, a hard disk, or the like; and a communication apparatus 1309. The communication apparatus 1309 may allow electronic device 1300 to communicate wirelessly or wired with other devices to exchange data. While FIG. 13 illustrates an electronic device 900 with a variety of component, it should be understood that it is not required that all of the illustrated components be implemented or provided. More or fewer components may alternatively be implemented or provided.

In particular, the processes described above with reference to the flowcharts may be implemented as computer software programs in accordance with embodiments of the present disclosure. For example, embodiments of the present disclosure include a computer program product comprising a computer program carried on a computer readable medium. The computer program comprises a program code for executing the method as shown in the flowchart. In such an embodiment, the computer program may be downloaded and installed from the network via communications apparatus 1309, or installed from storage apparatus 1308, or installed from ROM 1302. When the computer program is executed by the processing apparatus 1301, the above-described functions defined in the method of embodiments of the present disclosure are executed.

It should be noted that the computer readable medium in the present disclosure may be a computer readable signal medium or a computer readable storage medium, or any combination thereof. A computer readable storage medium may be, for example, but not limited to, an electronic, magnetic, optical, electromagnetic, infrared, or semiconductor system, apparatus, or device, or any suitable combination of the foregoing. More specific examples of the computer readable storage medium may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain or store a program for use by or in connection with an instruction execution system, apparatus, or device. While in the present disclosure, a computer readable signal medium may include a propagated data signal with computer readable program code embodied therein, for example, in baseband or as part of a carrier wave. Such a propagated signal may take any of a variety of forms, including, but not limited to, electro-magnetic signal, optical signal, or any suitable combination thereof. A computer readable signal medium may also be any computer readable medium that is not a computer readable storage medium and that can sent, propagate, or transport a program for use by or in connection with an instruction execution system, apparatus, or device. Program code embodied on a computer readable medium may be transmitted using any appropriate medium, including, but not limited to, wireline, optical fiber cable, RF (radio frequency), etc., or any suitable combination of the foregoing.

The computer readable medium may be included in the electronic device, or may exist separately and not be installed in the electronic device.

The computer readable medium carries one or more programs, and when the one or more programs are executed by the electronic device, the electronic device is enabled to execute the method shown in the foregoing embodiments.

Computer program code for carrying out operations for aspects of the present disclosure may be written in any combination of one or more programming languages, including an object oriented programming language such as Java, Smalltalk, C++ or the like and conventional procedural programming languages, such as the ‘C’ programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, a program segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart, and combinations of blocks in the block diagrams and/or flowchart, can be implemented by special purpose hardware-based systems that perform the specified functions or acts, or combinations of special purpose hardware and computer instructions.

The modules involved in the embodiments of the present disclosure may be implemented through software or hardware. The name of a module does not constitute a limitation to the module itself in some cases, for example, the determining module may also be described as “module configured for determining a music template”.

The functions described herein above may be performed, at least in part, by one or more hardware logic components. For example, without limitation, exemplary types of hardware logic components that can be used include Field-programmable Gate Arrays (FPGAs), Program-specific Integrated Circuits (ASICs), Application-specific Standard Products (ASSPs), System-on-a-chip systems (SOCs), Complex Programmable Logic Devices (CPLDs), etc.

In the context of this disclosure, a machine-readable medium may be tangible media that may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of machine-readable storage media include an electrical connection based on one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination of the foregoing.

In a first aspect, according to one or more embodiments of the present disclosure, a method for generating music is provided, comprising:
determining a music template, the music template comprising a plurality of tracks, each track being divided into at least one time period, and the plurality of tracks being orchestrated tracks of music; (S701)
obtaining a multimedia segment corresponding to each time period of each track from a database according to the music template, wherein the multimedia segment corresponding to each time period of each track comprises audio information obtained by a user playing a track melody corresponding to the time period of the track, and the database comprises a plurality of multimedia segments played by a plurality of users;
joining audio information in multimedia segments corresponding to respective time periods of each track respectively, to obtain a track audio corresponding to each track; and
generating target music by combining the track audio corresponding to respective tracks.

According to one or more embodiments of this disclosure, for any track in the plurality of tracks, joining the audio information in the multimedia segments corresponding to the respective time periods of the track to obtain the track audio corresponding to each track comprises:
determining a track type of the track, the track type including a melody track type, an accompaniment track type or a percussion track type; and
joining, according to the track type of the track, the audio information in the multimedia segments corresponding to the respective time periods of the track to obtain the track audio corresponding to the track.

According to one or more embodiments of this disclosure, the track type is a melody track type, and joining, according to the track type of the track, the audio information in the multimedia segments corresponding to the respective time periods of the track to obtain the track audio corresponding to the track comprises:
performing first processing on audio information in a multimedia segment corresponding to each time period of the track respectively, to obtain an intermediate multimedia segment corresponding to the time period, the first processing comprising at least one of: high-pitch correcting processing and reverberation adding processing; and
joining the audio information in the intermediate multimedia segments corresponding to the respective time periods of the track to obtain the track audio corresponding to the track.

According to one or more embodiments of this disclosure, the track type is an accompaniment track type, and joining, according to the track type of the track, the audio information in the multimedia segments corresponding to respective time periods of the track to obtain the track audio corresponding to the track comprises:
performing second processing on audio information in a multimedia segment corresponding to each time period of the track respectively, to obtain an intermediate multimedia segment corresponding to the time period, the second processing comprising at least one of: high-pitch correcting processing, reverberation adding processing, and low-frequency enhancing processing; and
joining the audio information in the intermediate multimedia segments corresponding to the respective time periods of the track to obtain the track audio corresponding to the track.

According to one or more embodiments of this disclosure, the track type is a percussion track type, and joining, according to the track type of the track, the audio information in the multimedia segments corresponding to the respective time period of the track to obtain the track audio corresponding to the track comprises:
performing third processing on audio information in a multimedia segment corresponding to each time period of the track respectively, to obtain an intermediate multimedia segment corresponding to the time period, the third processing comprising at least one of: high-pass filtering processing and reverberation adding processing; and
joining the audio information in the intermediate multimedia segments corresponding to the respective time periods of the track to obtain the track audio corresponding to the track.

According to one or more embodiments of this disclosure, generating the target music by combining the track audio corresponding to respective tracks comprises:
determining a predetermined volume corresponding to the music template;
balancing volume of the track audio corresponding to each track according to the predetermined volume; and
combining and noise-reducing the track audio of the respective tracks after the volume being balanced to obtain the target music.

According to one or more embodiments of this disclosure, the multimedia segment further comprises video information, and the method further comprises:
obtaining a video template and a play time of each multimedia segment, the video template comprising a video window corresponding to each track;
determining at least one multimedia segment corresponding to each video window;
with respect to any video window, according to the play time of the at least one multimedia segment corresponding to the video window, connecting the video information in the multimedia segment corresponding to the video window serially, to obtain a track video corresponding to the video window; and
adding the track video corresponding to each video window to the corresponding video window respectively, to obtain a target video corresponding to the target music.

According to one or more embodiments of this disclosure, the method further comprises:
sending the target music and the target video to a terminal device.

In a second aspect, according to one or more embodiments of this disclosure, a method for generating music is provided, comprising:
displaying a plurality of tracks of a music template, each track being divided into at least one time period, and the plurality of tracks being orchestrated tracks of the music; (S301)
in response to a selection operation for a first time period, displaying a multimedia recording page corresponding to the first time period, the first time period being any of time periods corresponding to the plurality of tracks; and
recording multimedia information within a recording time period corresponding to the multimedia recording page, to obtain a first multimedia segment corresponding to the first time period, and sending the first multimedia segment to a server.

According to one or more embodiments of this disclosure, the multimedia recording page comprises a start control and a stop control; recording the multimedia information within the recording time period corresponding to the multimedia recording page, to obtain the first multimedia segment corresponding to the first time period, comprises:
in response to a click operation on the start control, starting recording the multimedia information until a click operation on the stop control is received or the recording of the multimedia information is stopped at an end time of the recording time period, to obtain the first multimedia segment.

According to one or more embodiments of this disclosure, the multimedia recording page further comprises an information prompt region; the method further comprising:
obtaining a recording progress of the multimedia information;
displaying prompt information in the information prompt region according to the recording progress, the prompt information comprising at least one of lyrics and a musical note.

In a third aspect, according to one or more embodiments of this disclosure, an apparatus for generating music is provided, comprising:
a determining module configured to determine a music template, the music template comprising a plurality of tracks, each track being divided into at least one time period, and the plurality of tracks being orchestrated tracks of music;
an acquiring module configured to acquire a multimedia segment corresponding to each time period of each track from a database according to the music template, wherein the multimedia segment corresponding to each time period of each track comprises audio information obtained by a user playing a track melody corresponding to the time period of the track, and the database comprises a plurality of multimedia segments played by a plurality of users;
a processing module configured to join audio information in multimedia segments corresponding to respective time periods of each track respectively, to obtain a track audio corresponding to each track; and
a generating module configured to generate target music by combining the track audio corresponding to respective tracks.

According to one or more embodiments of this disclosure, for any track in the plurality of tracks, the processing module is configured for:
determining a track type of the track, the track type including a melody track type, an accompaniment track type or a percussion track type; and
joining, according to the track type of the track, the audio information in the multimedia segments corresponding to the respective time periods of the track to obtain the track audio corresponding to the track.

According to one or more embodiments of this disclosure, the track type is a melody track type, and the processing module is specifically configured for:
performing first processing on audio information in a multimedia segment corresponding to each time period of the track respectively, to obtain an intermediate multimedia segment corresponding to the time period, the first processing comprising at least one of: high-pitch correcting processing and reverberation adding processing; and
joining the audio information in the intermediate multimedia segments corresponding to the respective time periods of the track to obtain the track audio corresponding to the track.

According to one or more embodiments of this disclosure, the track type is an accompaniment track type, and the processing module is specifically configured for:
performing second processing on audio information in a multimedia segment corresponding to each time period of the track respectively, to obtain an intermediate multimedia segment corresponding to the time period, the second processing comprising at least one of: high-pitch correcting processing, reverberation
joining the audio information in the intermediate multimedia segments corresponding to the respective time periods of the track to obtain the track audio corresponding to the track.

According to one or more embodiments of this disclosure, the track type is a percussion track type, and the processing module is specifically configured for:
performing third processing on audio information in a multimedia segment corresponding to each time period of the track respectively, to obtain an intermediate multimedia segment corresponding to the time period, the third processing comprising at least one of: high-pass filtering processing and reverberation adding processing; and
joining the audio information in the intermediate multimedia segments corresponding to the respective time periods of the track to obtain the track audio corresponding to the track.

According to one or more embodiments of this disclosure, the generating module is specifically configured for:
determining a predetermined volume corresponding to the music template;
balancing volume of the track audio corresponding to each track according to the predetermined volume; and
combining and noise-reducing the track audio of the respective tracks after the volume being balanced to obtain the target music.

According to one or more embodiments of this disclosure, the multimedia segment further comprises video information, and the acquiring module is configured for: obtaining a video template and a play time of each multimedia segment, the video template comprising a video window corresponding to each track;
the processing module is further configured for determining at least one multimedia segment corresponding to each video window; with respect to any video window, according to the play time of the at least one multimedia segment corresponding to the video window, connecting the video information in the multimedia segment corresponding to the video window serially, to obtain a track video corresponding to the video window; and
the processing module is further configured for adding the track video corresponding to each video window to the corresponding video window respectively, to obtain a target video corresponding to the target music.

According to one or more embodiments of this disclosure, the apparatus further comprises:
a sending module configured for sending the target music and the target video to a terminal device.

In a fourth aspect, according to one or more embodiments of this disclosure, an apparatus for generating music is provided, comprising:
a displaying module configured to display a plurality of tracks of a music template, each track being divided into at least one time period, and the plurality of tracks being orchestrated tracks of the music;
the displaying module configured to, in response to a selection operation for a first time period, display a multimedia recording page corresponding to the first time period, the first time period being any of the time periods corresponding to the plurality of tracks;
a generating module configured to record multimedia information within a recording time period corresponding to the multimedia recording page, to obtain a first multimedia segment corresponding to the first time period; and
a sending module configured to send the first multimedia segment to a server.

According to one or more embodiments of this disclosure, the multimedia recording page comprises a start control and a stop control; the generating module is specifically configured for:
in response to a click operation on the start control, starting recording the multimedia information until a click operation on the stop control is received or the recording of the multimedia information is stopped at an end time of the recording time period, to obtain the first multimedia segment.

According to one or more embodiments of this disclosure, the multimedia recording page further comprises an information prompt region; the displaying module is further configured for:
obtaining a recording progress of the multimedia information;
displaying prompt information in the information prompt region according to the recording progress, the prompt information comprising at least one of lyrics and a musical note.

In a fifth aspect, according to one or more embodiment of this disclosure, an electronic device is provided, comprising: a processor and a memory;
the memory storing a computer execution instruction;
the processor executing the computer execution instruction to implement the method for generating music of the first aspect and its various possible implementations or the method for generating music of the second aspect and its various possible implementations.

In a sixth aspect, according to one or more embodiments of this disclosure, a computer readable storage medium having a computer execution instruction stored thereon is provided, the computer execution instruction, when executed by a processor, implementing the method for generating music of the first aspect and its various possible implementations or the method for generating music of the second aspect and its various possible implementations.

In a seventh aspect, according to one or more embodiments of this disclosure, a computer program product comprising a computer program is provided, the computer program, when executed by a processor, implementing the method for generating music of the first aspect and its various possible implementations or the method for generating music of the second aspect and its various possible implementations.

In a eighth aspect, according to one or more embodiments of this disclosure, a computer program is provided, when executed by a processor, implements the method for generating music of the first aspect and its various possible implementations or the method for generating music of the second aspect and its various possible implementations.

The foregoing description is merely illustrative of the preferred embodiments of the present disclosure and of the technical principles applied thereto. As will be appreciated by those skilled in the art, the disclosure of the present disclosure is not limited to the technical solution formed by the specific combination of the described technical features, it should also cover other technical solutions formed by any combination of the described technical features or equivalent features thereof without departing from the described disclosed concept. For example, the above features and technical features having similar functions disclosed in the present disclosure (but not limited thereto) are replaced with each other to form a technical solution.

In addition, while operations are depicted in a particular order, this should not be understood as requiring that the operations be performed in the particular order shown or in sequential order. Multitasking and parallel processing may be advantageous in certain circumstances. Likewise, while several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

1. A method for generating music, comprising:
determining a music template, the music template comprising a plurality of tracks, each track being divided into at least one time period, and the plurality of tracks being orchestrated tracks of music;
obtaining a multimedia segment corresponding to each time period of each track from a database according to the music template, wherein the multimedia segment corresponding to each time period of each track comprises audio information obtained by a user playing a track melody corresponding to the time period of the track, and the database comprises a plurality of multimedia segments played by a plurality of users;
joining audio information in multimedia segments corresponding to respective time periods of each track respectively, to obtain a track audio corresponding to each track; and
generating target music by combining the track audio corresponding to respective tracks.

2. The method of claim 1, wherein for any track in the plurality of tracks, joining the audio information in the multimedia segments corresponding to the respective time periods of the track to obtain the track audio corresponding to each track comprises:
determining a track type of the track, the track type including a melody track type, an accompaniment track type or a percussion track type; and
joining, according to the track type of the track, the audio information in the multimedia segments corresponding to the respective time periods of the track to obtain the track audio corresponding to the track.

3. The method of claim 2, wherein the track type is a melody track type, and joining, according to the track type of the track, the audio information in the multimedia segments corresponding to the respective time periods of the track to obtain the track audio corresponding to the track comprises:
performing first processing on audio information in a multimedia segment corresponding to each time period of the track respectively, to obtain an intermediate multimedia segment corresponding to the time period, the first processing comprising at least one of: high-pitch correcting processing and reverberation adding processing; and
joining the audio information in the intermediate multimedia segments corresponding to the respective time periods of the track to obtain the track audio corresponding to the track.

4. The method of claim 2, wherein the track type is an accompaniment track type, and joining, according to the track type of the track, the audio information in the multimedia segments corresponding to respective time periods of the track to obtain the track audio corresponding to the track comprises:
performing second processing on audio information in a multimedia segment corresponding to each time period of the track respectively, to obtain an intermediate multimedia segment corresponding to the time period, the second processing comprising at least one of: high-pitch correcting processing, reverberation adding processing, and low-frequency enhancing processing; and
joining the audio information in the intermediate multimedia segments corresponding to the respective time periods of the track to obtain the track audio corresponding to the track.

5. The method of claim 2, wherein the track type is a percussion track type, and joining, according to the track type of the track, the audio information in the multimedia segments corresponding to the respective time period of the track to obtain the track audio corresponding to the track comprises:
performing third processing on audio information in a multimedia segment corresponding to each time period of the track respectively, to obtain an intermediate multimedia segment corresponding to the time period, the third processing comprising at least one of: high-pass filtering processing and reverberation adding processing; and
joining the audio information in the intermediate multimedia segments corresponding to the respective time periods of the track to obtain the track audio corresponding to the track.

6. The method of claim 1, wherein generating the target music by combining the track audio corresponding to respective tracks comprises:
determining a predetermined volume corresponding to the music template;
balancing volume of the track audio corresponding to each track according to the predetermined volume; and
combining and noise-reducing the track audio of the respective tracks after the volume being balanced to obtain the target music.

7. The method of claim 1, wherein the multimedia segment further comprises video information, and the method further comprises:
obtaining a video template and a play time of each multimedia segment, the video template comprising a video window corresponding to each track;
determining at least one multimedia segment corresponding to each video window;
with respect to any video window, according to the play time of the at least one multimedia segment corresponding to the video window, connecting the video information in the multimedia segment corresponding to the video window serially, to obtain a track video corresponding to the video window; and
adding the track video corresponding to each video window to the corresponding video window respectively, to obtain a target video corresponding to the target music.

8. The method of claim 7, further comprising:
sending the target music and the target video to a terminal device.

9. A method for generating music, comprising:
displaying a plurality of tracks of a music template, each track being divided into at least one time period, and the plurality of tracks being orchestrated tracks of the music;
in response to a selection operation for a first time period, displaying a multimedia recording page corresponding to the first time period, the first time period being any of time periods corresponding to the plurality of tracks; and
recording multimedia information within a recording time period corresponding to the multimedia recording page, to obtain a first multimedia segment corresponding to the first time period, and sending the first multimedia segment to a server.

10. The method of claim 9, wherein the multimedia recording page comprises a start control and a stop control; recording the multimedia information within the recording time period corresponding to the multimedia recording page, to obtain the first multimedia segment corresponding to the first time period, comprises:
in response to a click operation on the start control, starting recording the multimedia information until a click operation on the stop control is received or the recording of the multimedia information is stopped at an end time of the recording time period, to obtain the first multimedia segment.

11. The method of claim 9, wherein the multimedia recording page further comprises an information prompt region; the method further comprising:
obtaining a recording progress of the multimedia information;
displaying prompt information in the information prompt region according to the recording progress, the prompt information comprising at least one of lyrics and a musical note.

12. (canceled)

13. (canceled)

14. An electronic device, comprising: a processor and a memory;
the memory storing a computer execution instruction;
the processor executing the computer execution instruction to implement acts comprising:
determining a music template, the music template comprising a plurality of tracks, each track being divided into at least one time period, and the plurality of tracks being orchestrated tracks of music;
obtaining a multimedia segment corresponding to each time period of each track from a database according to the music template, wherein the multimedia segment corresponding to each time period of each track comprises audio information obtained by a user playing a track melody corresponding to the time period of the track, and the database comprises a plurality of multimedia segments played by a plurality of users;
joining audio information in multimedia segments corresponding to respective time periods of each track respectively, to obtain a track audio corresponding to each track; and
generating target music by combining the track audio corresponding to respective tracks.

15. (canceled)

16. (canceled)

17. (canceled)

18. The method of claim 9, wherein the selection operation is made by user according to descriptive information of respective time periods of the track.

19. The electronic device of claim 14, wherein for any track in the plurality of tracks, joining the audio information in the multimedia segments corresponding to the respective time periods of the track to obtain the track audio corresponding to each track comprises:
determining a track type of the track, the track type including a melody track type, an accompaniment track type or a percussion track type; and
joining, according to the track type of the track, the audio information in the multimedia segments corresponding to the respective time periods of the track to obtain the track audio corresponding to the track.

20. The electronic device of claim 19, wherein the track type is a melody track type, and joining, according to the track type of the track, the audio information in the multimedia segments corresponding to the respective time periods of the track to obtain the track audio corresponding to the track comprises:
performing first processing on audio information in a multimedia segment corresponding to each time period of the track respectively, to obtain an intermediate multimedia segment corresponding to the time period, the first processing comprising at least one of: high-pitch correcting processing and reverberation adding processing; and
joining the audio information in the intermediate multimedia segments corresponding to the respective time periods of the track to obtain the track audio corresponding to the track.

21. The electronic device of claim 19, wherein the track type is an accompaniment track type, and joining, according to the track type of the track, the audio information in the multimedia segments corresponding to respective time periods of the track to obtain the track audio corresponding to the track comprises:
performing second processing on audio information in a multimedia segment corresponding to each time period of the track respectively, to obtain an intermediate multimedia segment corresponding to the time period, the second processing comprising at least one of: high-pitch correcting processing, reverberation adding processing, and low-frequency enhancing processing; and
joining the audio information in the intermediate multimedia segments corresponding to the respective time periods of the track to obtain the track audio corresponding to the track.

22. The electronic device of claim 19 wherein the track type is a percussion track type, and joining, according to the track type of the track, the audio information in the multimedia segments corresponding to the respective time period of the track to obtain the track audio corresponding to the track comprises:
performing third processing on audio information in a multimedia segment corresponding to each time period of the track respectively, to obtain an intermediate multimedia segment corresponding to the time period, the third processing comprising at least one of: high-pass filtering processing and reverberation adding processing; and
joining the audio information in the intermediate multimedia segments corresponding to the respective time periods of the track to obtain the track audio corresponding to the track.

23. The electronic device of claim 14, wherein generating the target music by combining the track audio corresponding to respective tracks comprises:
determining a predetermined volume corresponding to the music template;
balancing volume of the track audio corresponding to each track according to the predetermined volume; and
combining and noise-reducing the track audio of the respective tracks after the volume being balanced to obtain the target music.

24. The electronic device of claim 14, wherein the multimedia segment further comprises video information, and the acts further comprises:
obtaining a video template and a play time of each multimedia segment, the video template comprising a video window corresponding to each track;
determining at least one multimedia segment corresponding to each video window;
with respect to any video window, according to the play time of the at least one multimedia segment corresponding to the video window, connecting the video information in the multimedia segment corresponding to the video window serially, to obtain a track video corresponding to the video window; and
adding the track video corresponding to each video window to the corresponding video window respectively, to obtain a target video corresponding to the target music.

25. The electronic device of claim 24, the acts further comprising:
sending the target music and the target video to a terminal device.
